(19) United States
(12) Patent Application Publication
(10) Pub. No.: US 2014/0189408 A1
(43) Pub. Date: Jul. 3, 2014

(54) SYSTEM AND METHOD FOR REDUCING POWER CONSUMPTION

(71) Applicants: Robert Gough, Sherwood, OR (US); Mazen Gedeon, Hillsboro, OR (US); Barnes Cooper, Tigard, OR (US); Basavaraj Astekar, Hillsboro, OR (US)

(72) Inventors: Robert Gough, Sherwood, OR (US); Mazen Gedeon, Hillsboro, OR (US); Barnes Cooper, Tigard, OR (US); Basavaraj Astekar, Hillsboro, OR (US)

(21) Appl. No.: 13/730,573

(22) Filed: Dec. 28, 2012

(51) Int. Cl. G06F 1/32

(52) U.S. Cl. CPC G06F 1/3287
USPC 713/324

(57) ABSTRACT

Particular embodiments described herein can offer an apparatus that includes logic, the logic at least partially comprising hardware logic to receive a first notification indicating that at least one first user interaction device has become precluded; and cause, by a processor and absent intermediate operation of operating system software, disabling of at least one second user interaction device based, at least in part, on the first notification.

### TECHNICAL FIELD

Embodiments described herein generally relate to providing for power savings in a processor environment.

### BACKGROUND

As electronic apparatuses become more complex and ubiquitous in the everyday lives of users, more and more diverse requirements are placed upon them. For example, many electronic apparatuses can operate on battery power, thus allowing users to operate these devices in many different circumstances. In addition, as capabilities of electronic apparatuses become more extensive, many users may become reliant on the enhanced performance such capabilities provide. As these aspects of electronic apparatuses have evolved, there has become an increasing need for reducing power consumption. However, as capabilities of electronic apparatuses have increased, the amount of heat generated by electronic apparatuses has increased as well. Many electronic apparatuses contain devices for user interaction. It may be desirable to save power associated with these user interaction devices.

### BRIEF DESCRIPTION OF THE DRAWINGS

Embodiments are illustrated by way of example and not by way of limitation in the FIGURES of the accompanying drawings, in which like references indicate similar elements and in which:

FIG. 1 is a block diagram illustrating components associated with a user interaction device according to at least one example embodiment;

FIG. 2 is a block diagram illustrating software components associated with a user interaction device according to at least one example embodiment;

FIG. 3 is a flow diagram showing a set of operations for causing disabling of a user interaction device according to at least one example embodiment;

FIG. 4 is another flow diagram showing a set of operations for causing disabling of a user interaction device according to at least one example embodiment;

FIGS. 5A-5D are interaction diagrams showing communication associated with causing disabling of a user interaction device according to at least one example embodiment;

FIGS. 6A-6D are other interaction diagrams showing communication associated with causing disabling of a user interaction device according to at least one example embodiment;

FIG. 7 is still another flow diagram showing a set of operations for causing disabling of a user interaction device according to at least one example embodiment;

FIG. 8 is yet another flow diagram showing a set of operations for causing disabling of a user interaction device according to at least one example embodiment;

FIG. 9 is a simplified block diagram associated with an example ARM ecosystem system on chip (SOC) of the present disclosure; and

FIG. 10 is a simplified block diagram illustrating example logic that may be used to execute activities associated with the present disclosure.

The FIGURES of the drawings are not necessarily drawn to scale or proportion, as their dimensions, arrangements, and specifications can be varied considerably without departing from the scope of the present disclosure.

### DETAILED DESCRIPTION OF EXAMPLE EMBODIMENTS

The following detailed description sets forth example embodiments of apparatuses, methods, and systems relating to providing a power savings in a processor environment. Features such as structure(s), function(s), and/or characteristic(s), for example, are described with reference to one embodiment as a matter of convenience; various embodiments may be implemented with any suitable one or more of the described features.

As power saving requirements become stricter, it becomes increasingly desirable to reduce power consumption for various devices of an apparatus. For example, there are circumstances where a user is not utilizing a user interaction device. Under such circumstances, it may be desirable to disable the user interaction device so that it is not consuming as much power.

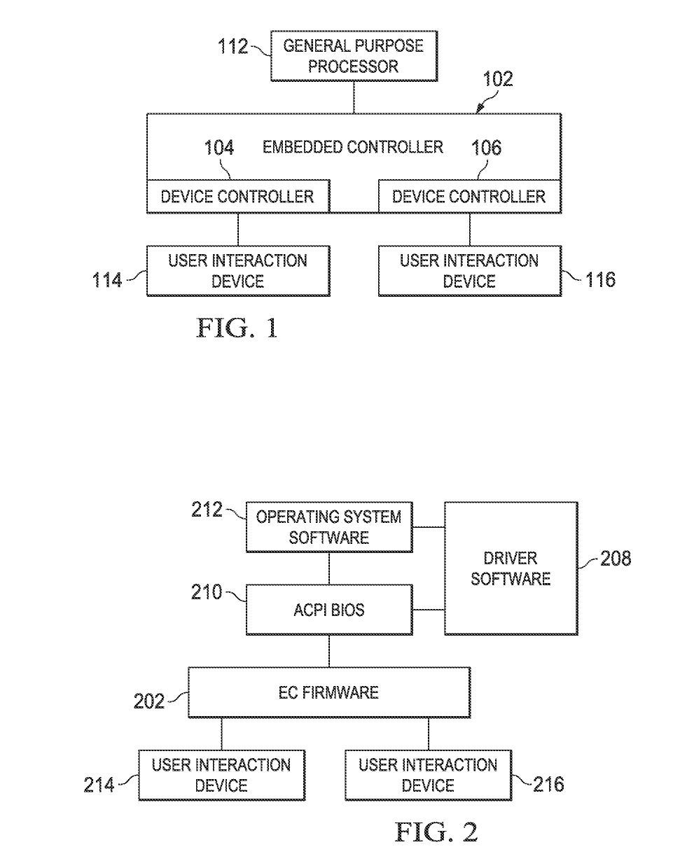

FIG. 1 is a block diagram illustrating components associated with a user interaction device according to at least one example embodiment. The example of FIG. 1 is merely an example of components associated with a user interaction device, and does not limit the scope of the claims. For example, operations attributed to a component may vary, number of components may vary, composition of a component may vary, and/or the like. For example, in some example embodiments, operations attributable to one component of the example of FIG. 1 may be allocated to one or more other components.

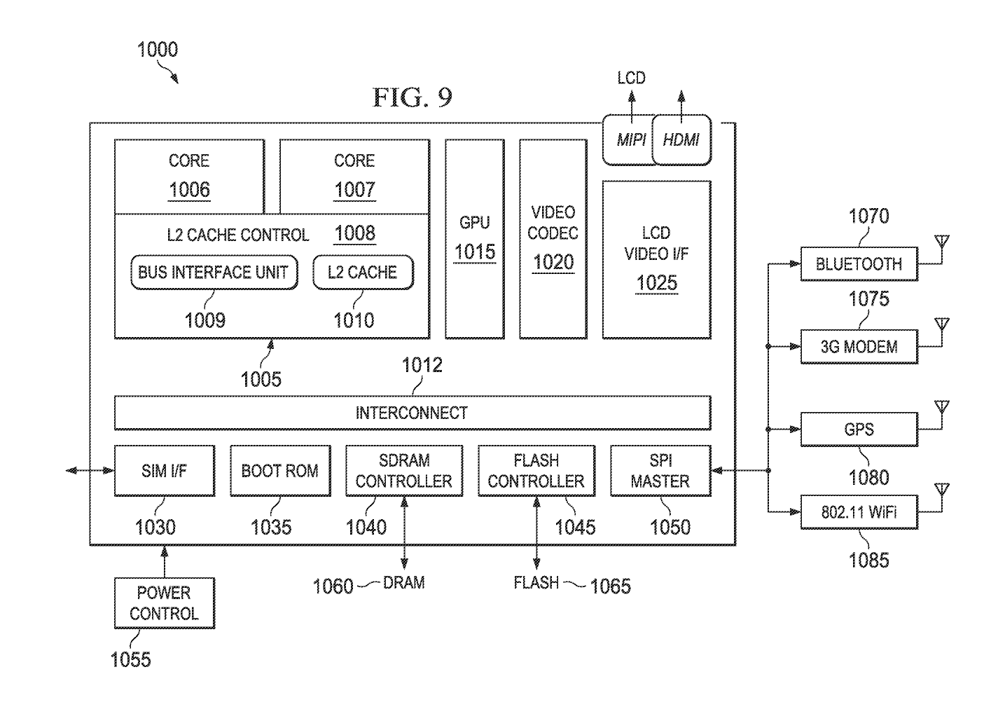

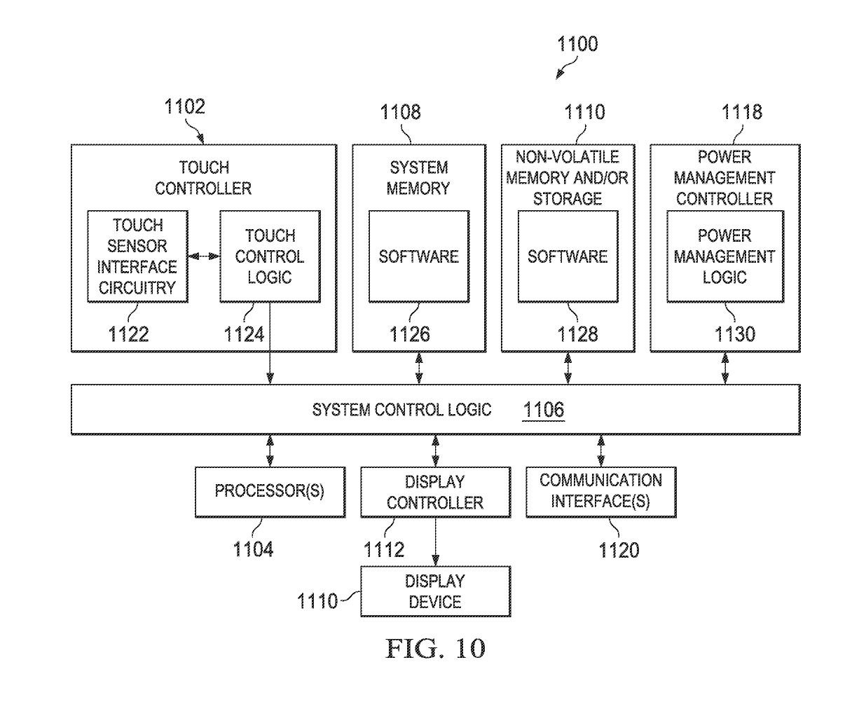

In the example of FIG. 1, processor 112 is in communication with embedded controller 102. Processor 112 may relate to any processor, general purpose processor, and/or the like. For example, core 1006 and/or core 1007, of FIG. 9, may comprise processor 112. In another example, processor 1104 of FIG. 10 may comprise processor 112. Embedded controller 102 may relate to any controller that interacts with, and/or controls, one or more devices. For example, embedded controller 102 may comprise, or may be, a platform controller hub (PCH), an input/output controller hub (ICH), and or the like. In another example, embedded controller 102 may relate to LCD video I/F 1025 of FIG. 9, SPI Master 1050 of FIG. 9, power management controller 1118 of FIG. 10, display controller 1112 of FIG. 10, communication interfaces 1120 of FIG. 10, and/or the like.

In the example of FIG. 1, embedded controller 102 comprises device controller 104 and device controller 106. Device controller 104 may be in communication with user interaction device 114. Device controller 106 may be in communication with user interaction device 116. In at least one example embodiment, a user interaction device is a device that provides information to a user and/or receives input from a user. In at least one example embodiment, a user interaction device comprises a user input device, such as a keypad, pointer device, motion sensor, and/or the like. In at least one example embodiment, a keypad relates to a device that provides one or more buttons that a user may select by performing a keypress. In at least one example embodiment, a pointer device relates to a device associated with a positional and/or directional input. A pointer input may relate to a trackpoint, a touchpad, a trackball, and/or the like. For example, a pointer input may relate to a mouse. In another example, a pointer input may relate to a touch sensor of a touch display. In at least one example embodiment, a touch sensor of a touch display is a sensor that is configured to detect positional touch input in relation to a display. A touch sensor may comprise a touch sensor that overlays a display. In at least one example embodiment, a user interaction device comprises a user output device, such as a display, a light, a haptic device, a speaker, and/or the like.

In at least one example embodiment, the components of FIG. 1 may receive and/or send information to each other. For example, device controller 104 may receive and/or send information to user interaction device 114, such as a notification, content, a control signal, and/or the like. For example, a device controller may receive a notification from a user interaction device that indicates information regarding the user interaction device. In another example, a device controller may provide control of a user interaction device. In such an example, the device controller may enable and/or disable the user interaction device. In at least one example embodiment, enabling the user interaction device comprises providing power to the user interaction device, instructing the user interaction device to acquire input, instructing the user interaction device to provide output, and/or the like. For example, a keypad, pointer device, a touch sensor, and/or the like, may be enabled by provision of power, causing scanning for a keypress, causing scanning of a touch input and/or the like. In another example, a user output device, such as a display, a speaker, a haptic device, and/or the like, may be enabled by provision of power, causing information to be sent, causing information to be rendered, causing information to be played, and/or the like.

In at least one example embodiment, disabling the user interaction device comprises disabling power to the user interaction device, instructing the user interaction device to forgo acquiring input, instructing the user interaction device to forgo providing output, and/or the like. For example, a keypad, pointer device, a touch sensor, and/or the like, may be disabled by eliminating provision of power, disabling scanning for a keypress, disabling scanning of a touch input and/or the like. In another example, a user output device, such as a display, a speaker, a haptic device, and/or the like, may be disabled by eliminating provision of power, precluding information being sent, precluding information being rendered, precluding information being played, and/or the like.

FIG. 2 is a block diagram illustrating software components associated with a user interaction device according to at least one example embodiment. The example of FIG. 2 is merely an example of software components, and does not limit the scope of the claims. For example, operations attributed to a software component may vary, number of software components may vary, composition of a software component may vary, and/or the like. For example, in some example embodiments, operations attributable to one software component of the example of FIG. 2 may be allocated to one or more other software components.

In the example of FIG. 2, operating system software 212 is in communication with driver software 208 and advanced configuration power interface (ACM) basic input output software (BIOS) 210. Note that the present disclosure can be applicable to ACPI™ Revision 5.0, released in November 2011. Additionally, the present disclosure is applicable to any other version of the ACPI™ Specification. In at least one example embodiment, operating system software 212 comprises programs that provide common services for other programs. For example, operating system software 212 may comprise software that provides common interfaces for programs so that the programs are not dependent upon variation in hardware interfaces. In at least one example embodiment, operating system software comprises Android™, BSD, iOS™, Linux™, Mac OS X™, Microsoft Windows™, Windows Phone™, IBM z/OS™, and/or the like. Driver software 208 relates to software that an operating system uses to interact with devices and/or other hardware, such as a keypad device driver, a touchpad device driver, a display device driver, and/or the like. In the example of FIG. 2, driver software 208 is indicated as a single block. However, driver software 208 may comprise multiple software modules for software drivers. For example, there may be a first software driver associated with a first device and a second software driver associated with a second device. In at least one example embodiment, driver software may be associated with a device based on a relationship of information sharing and control. For example, a device may provide notifications, directly or by way of other components, to a device driver. Driver software may provide information to EC firmware directly and/or by way of ACPI DIOS 210. For example, driver software 208 may provide information to ACPI BIOS 210, which may cause ACPI Bios to provide information to EC firmware 202. Therefore, EC firmware 202 may receive a notification from driver software 208 directly and/or by way of a different software module, such as ACPI BIOS 210. In at least one example embodiment ACPI BIOS 210 is software that provides power management service to a system by way of receiving information relating to software and/or hardware operations and providing directives that affect hardware power consumption. In the example of FIG. 2, ACPI Bios 210 is in communication with embedded controller (EC) firmware 202. Embedded controller firmware 202 relates to software operations executed by an embedded controller. In at least one example embodiment, EC firmware 202 controls and/or interacts with devices. In the example of FIG. 2, EC firmware 202 is in communication with user interaction device 214 and user interaction device 216. User interaction devices 214 and 216 may be similar as described regarding user interaction devices 114 and 116 of FIG. 1.

In at least one example embodiment, a software module provides a notification to a different software module. For example, user interaction device 216 may provide a notification to EC firmware 202. The notification may indicate information. For example, a notification may indicate occurrence of an event. In at least one example embodiment, a software module causes a different software module to perform an operation. For example, a software module may provide a directive to a different software module that causes the different software module to perform an operation. In such an example, the software module may send a low power mode directive to the different software module.

In at least one example embodiment, operating system software 212, driver software 208, and ACPI BIOS 210 are associated with one or more general purpose processors, such as processor 112 of FIG. 1. For example, operations of operating system software 212, driver software 208, and ACPI BIOS 210 may be performed by the one or more general purpose processors. In at least one example embodiment, EC firmware 202 is associated with one or more embedded controllers, such as embedded controller 102 of FIG. 1. For example, operations of EC firmware 202 may be performed by the embedded controller.

In at least one example embodiment, operations are performed absent intermediate operation of operating system software 212. For example, a processor may execute operations such that no operations of operating system software 212 are invoked. For example operations of EC firmware 202, driver software 208, ACPI BIOS 210, and/or the like, may be executed absent execution of operations of operating system software 212. Without limiting the claims in any way, at least one technical advantage of executing operations absent operations of operating system software 212 is to allow for hardware sensitive tailoring of operations without impacting the operating system software regarding design, operations, complexity, and/or the like.

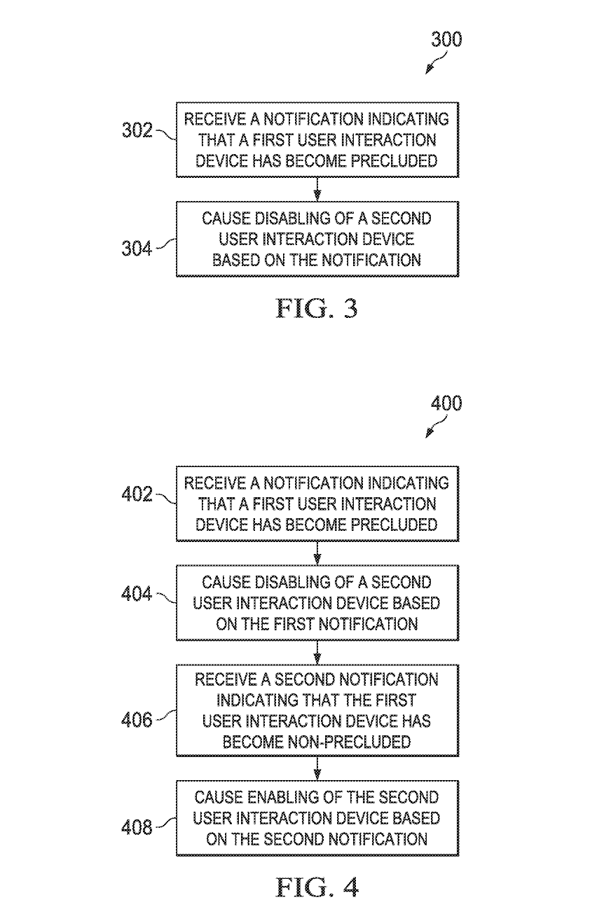

FIG. 3 is a flow diagram showing a set of operations 300 for causing disabling of a user interaction device according to at least one example embodiment. An apparatus, for example system 1100 of FIG. 10 or a portion thereof, may utilize the set of operations 300. The apparatus may comprise means, including, for example processor 1104 of FIG. 10, for performing the operations of FIG. 3. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 300. In at least one example embodiment, set of operations 300 are performed exclusive from operating system software.

During the operation of an electronic device, there may arise circumstances where a user will not be utilizing a user interaction device. Such circumstances relate to a user interaction device being precluded. For example, preclusion of a user interaction device may relate to circumstances where the user is not present at the electronic apparatus to perform any input or to receive any output. In another example, preclusion of a user interaction device may relate to circumstances where a mechanical configuration of the electronic apparatus impedes a user's ability to utilize a user interaction device. In still another example, preclusion of a user interaction device may relate to circumstances where unavailability of a first user interaction device impedes a user's ability to utilize a user interaction device. Preclusion of a user interaction device may relate to physical preclusion of a user interaction device, interactional preclusion of a user interaction device, user absence preclusion of a user interaction device, and/or the like.

In at least one example embodiment, physical preclusion of a user interaction device relates to circumstances where a mechanical configuration of an electronic apparatus impedes a user's ability to utilize a user interaction device. For example, there may be a configuration of the electronic device where a keypad is inaccessible to the user, such as a closed laptop, a closed flip-phone, a closed slider phone, and/or the like. In at least one example embodiment, physical preclusion relates to a user interaction device being physically obscured such that there is interference with the user's ability to access, perceive, and/or perform input regarding a user interaction device.

In at least one example embodiment, interactional preclusion of a user interaction device relates to circumstances where unavailability of a first user interaction device impedes a user's ability to utilize a second user interaction device. Interactional preclusion may relate to representational interaction preclusion, feedback interactional preclusion, and/or the like. In at least one example embodiment, representational preclusion relates to a user interaction device becoming unable to provide information to a user. For example, a display may become disabled, such as having power to the display terminated. In at least one example embodiment, representational interaction preclusion relates to circumstances where unavailability of a user interaction device associated with representing information impedes the user's ability to use a user interaction device associated with performing an operation associated with the information. For example, if a display is precluded, a user's ability to use a pointing device, such as a mouse, a touchpad, and/or the like, may be impeded, for at least the reason that lack of representation of any information to associate with a user's input regarding the pointing device causes difficulty for the user in comprehending the effect of performing input regarding the pointing device. In another example, if a display is precluded, the user's ability to use a touch sensor that positionally corresponds to at least part of the display, such as a touch display, may be impeded for at least the reason that the user will be unaware of any information to which the position of the touch input may correspond. In, at least, this regard, preclusion of a user interaction device may imply preclusion of a different user interaction device. In at least one example embodiment, feedback interaction preclusion relates to circumstances where unavailability of a first user interaction device associated with providing a feedback response to input performed on a second user interaction device impedes the user's ability to use the second user interaction device. For example, if a display is disabled, a user's utilization of a keypad may be impeded for at least the reason that the user may be unable to determine that the keypress caused the effect intended by the user, such as placing a character in a document.

At block 302, the apparatus receives a notification that at least one first user interaction device has become precluded. The preclusion may be similar as previously described. The notification may be received by way of a message, a function call, an electrical signal, and/or the like, from a software module, a hardware component, a device, and/or the like. The notification may indicate preclusion by providing information indicating preclusion, by the memorialization of an event representing the preclusion, and/or the like. For example, the receiving of the notification itself may indicate preclusion. The user interaction device may be similar as described regarding FIG. 1.

In at least one example embodiment, the notification may indicate that the user interaction device has become precluded by indicating that a user is absent. An operating system may determine that a user is absent based, at least in part on user activity, application activity, user inactivity, application inactivity, and/or the like.

In at least one example embodiment, the notification may indicate that the user interaction device has become physically precluded, interactionally precluded, representationally interactionally precluded, feedback interactionally precluded, and/or the like.

At block 304, the apparatus causes disabling of at least one second user interaction device based, at least in part, on the notification. In at least one example embodiment, the first user interaction device comprises the second user interaction device. For example, the notification may indicate physical preclusion of a keypad, and, at block 304, the apparatus may cause disabling of the keypad. The causing of disabling may be further based, at least in part, on determination that the indicated preclusion of the first user interaction device corresponds to a preclusion of the second device. For example, there may be a determination that the second user interaction device has an interactional dependency on the first user interaction device, such as between a display and a touch sensor. The disabling may be similar as described regarding FIG. 1.

In at least one example embodiment, causing disabling of the second user interaction device is based, at least in part, on the first notification in absence of operation of operating system software. For example, the operating system software may be unaware of preclusive implications of a user interaction device, unaware of preclusive implications of a user interaction device in regards to a different user interaction device. At least one technical advantage of performing block 304 absent intermediate operation of operating system software is to allow operating system software to be designed without dependency on mechanical and function preclusion relationships, which are dependent upon the design of the form factor and/or hardware of the apparatus. In at least one example embodiment, disabling is caused by sending a message, performing an operation, sending an electrical signal, and/or the like.

FIG. 4 is another flow diagram showing a set of operations 400 for causing disabling of a user interaction device according to at least one example embodiment. An apparatus, for example system 1100 of FIG. 10 or a portion thereof, may utilize the set of operations 400. The apparatus may comprise means, including, for example processor 1104 of FIG. 10, for performing the operations of FIG. 4. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 400. In at least one example embodiment, set of operations 400 are performed exclusive from operating system software.

At block 402, the apparatus receives a notification that at least one first user interaction device has become precluded, similar as described regarding block 302 of FIG. 3. At block 404, the apparatus causes disabling of at least one second user interaction device based, at least in part, on the notification, similar as described regarding block 304 of FIG. 3. In at least one example embodiment, the first user interaction device and the second user interaction device are the same. At block 406, the apparatus receives a second notification indicating that the at least one first user interaction device has become non-precluded. In at least one example embodiment, non-preclusion relates to a user interaction device being free from preclusion, having a preclusion removed, and/or the like. The receiving of the notification and the notification may be similar as described regarding block 404. At block 408, the apparatus causes enabling of the at least one second user interaction device based, at least in part, on the first notification. The enabling may be similar as described regarding FIG. 1. The causing may be similar as described regarding block 404 of FIG. 4.

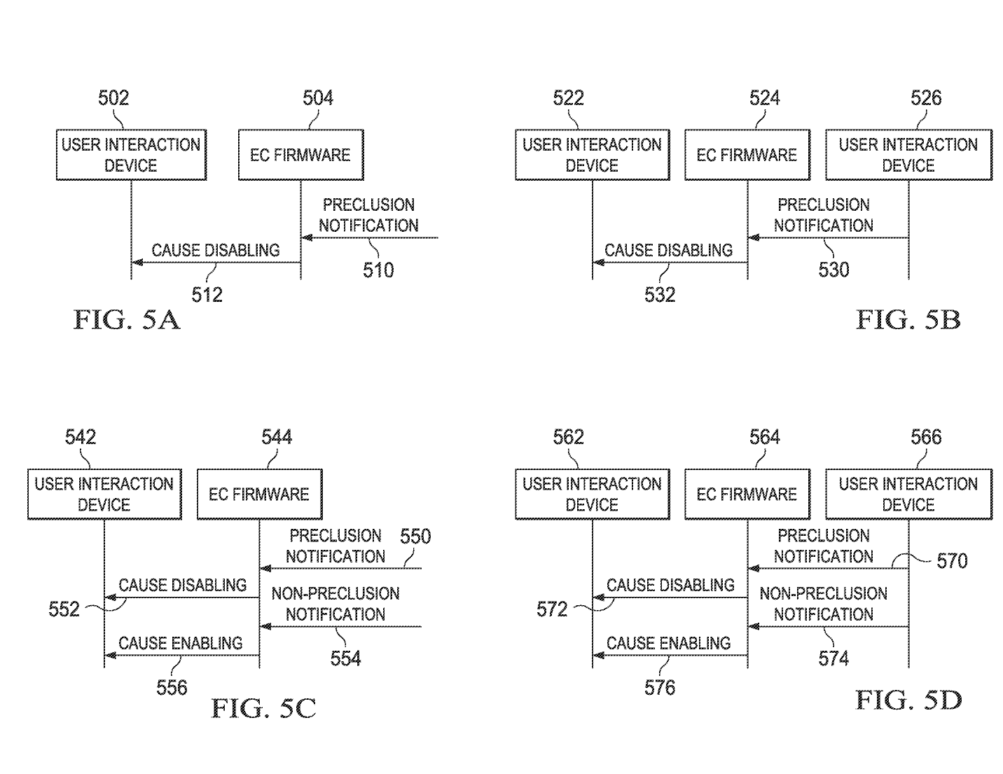

FIGS. 5A-5D are interaction diagrams showing communication associated with causing disabling of a user interaction device according to at least one example embodiment. The examples of FIGS. 5A-5D are merely examples of communication, and do not limit the scope of the claims. For example, number of modules may vary, specific communications may vary, order of communications may vary, and/or the like.

The example of FIGS. 5A-5D relate to interactions regarding user interaction device 502 and EC firmware 504. User interaction device 502 may be similar as described regarding user interaction device 214 of FIG. 2. EC firmware 504 may be similar as described regarding embedded controller firmware 102 of FIG. 2. It can be seen that the interactions and operations of FIGS. 5A-5D are performed absent intermediate operation of operating system software. The interactions of FIGS. 5A-5D may relate to any communication methodologies, such as messaging, function calls, electronic signaling, setting of variables, and/or the like.

In the example of FIG. 5A, EC firmware 504 receives interaction 510 communicating a preclusion notification. User interaction device 502 receives interaction 512 causing disabling of user interaction device 502. In this manner, EC firmware 504 causes disabling of the user interaction device by way of interaction 512. EC firmware 504 may further cause saving of context information associated with user interaction device 502. Saving context information may allow for restoration of user interaction device 502 after enablement.

In the example of FIG. 5B, EC firmware 524 receives interaction 530, from user interaction device 526, communicating a preclusion notification. User interaction device 522 receives interaction 532 causing disabling of user interaction device 522. In this manner, EC firmware 524 causes disabling of the user interaction device by way of interaction 532. EC firmware 524 may further cause saving of context information associated with user interaction device 522. Saving context information may allow for restoration of user interaction device 522 after enablement.

In the example of FIG. 5C, EC firmware 544 receives interaction 550 communicating a preclusion notification. User interaction device 542 receives interaction 552 causing disabling of the user interaction device. In this manner, EC firmware 544 causes disabling of the user interaction device by way of interaction 552. EC firmware 544 may further cause saving of context information associated with user interaction device 542. At a later time, EC firmware 544 receives interaction 554 communicating a non-preclusion notification. User interaction device 542 receives interaction 556 causing enabling of user interaction device 542. In this manner, EC firmware 544 causes enabling of the user interaction device by way of interaction 552. EC firmware 544 may further cause restoring of the previously saved context information associated with user interaction device 542.

In the example of FIG. 5D, EC firmware 564 receives interaction 570, from user interaction device 566, communicating a preclusion notification. User interaction device 562 receives interaction 572 causing disabling of the user interaction device. In this manner, EC firmware 564 causes disabling of the user interaction device by way of interaction 572. EC firmware 564 may further cause saving of context information associated with user interaction device 562. At a later time, EC firmware 564 receives interaction 574, from user interaction device 566, communicating a non-preclusion notification. User interaction device 562 receives interaction 576 causing enabling of user interaction device 562. In this manner, EC firmware 564 causes enabling of the user interaction device by way of interaction 572. EC firmware 564 may further cause restoring of the previously saved context information associated with user interaction device 562.

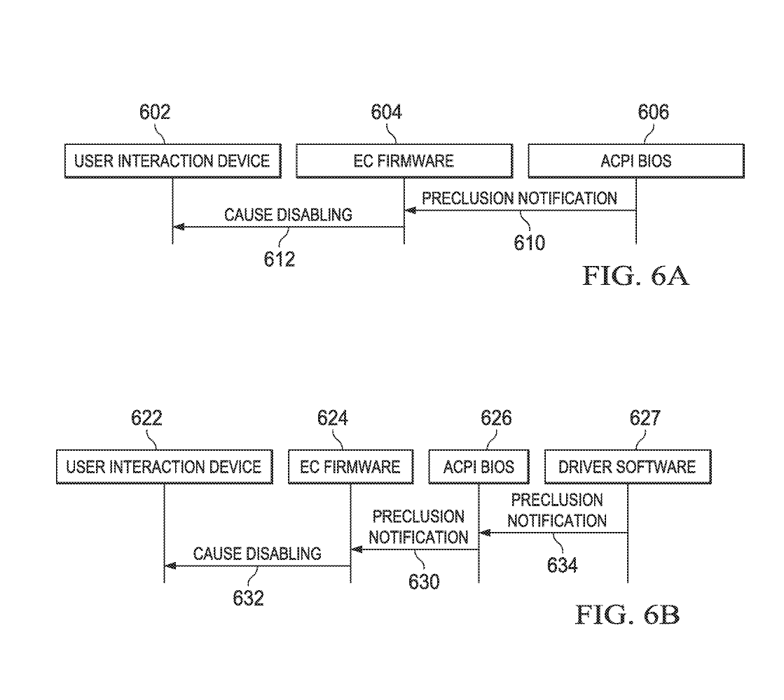

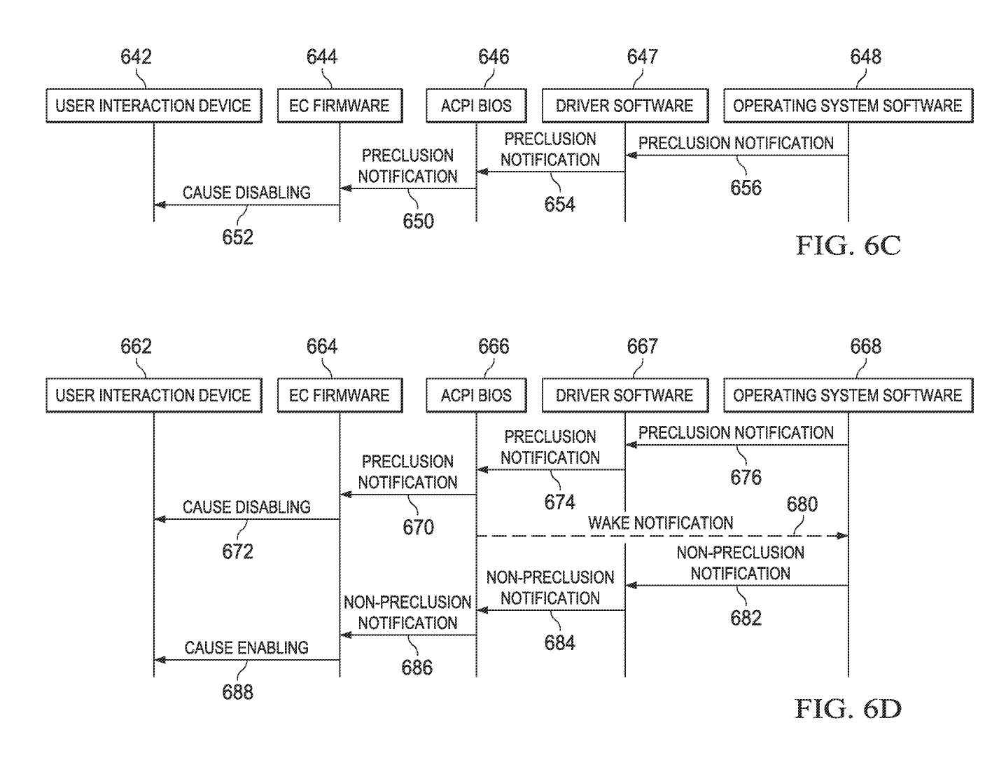

FIGS. 6A-6D are other interaction diagrams showing communication associated with causing disabling of a user interaction device according to at least one example embodiment. The examples of FIGS. 6A-6D are merely examples of communication, and do not limit the scope of the claims. For example, number of modules may vary, specific communications may vary, order of communications may vary, and/or the like.

The example of FIGS. 6A-6D relate to interactions regarding user interaction device 602 and EC firmware 604. User interaction device 602 may be similar as described regarding user interaction device 214 of FIG. 2. EC firmware 604 may be similar as described regarding embedded controller firmware 102 of FIG. 2. The interactions of FIGS. 6A-6D may relate to any communication methodologies, such as messaging, function calls, electronic signaling, setting of variables, and/or the like.

In the example of FIG. 6A, EC firmware 604 receives interaction 610, from user ACPI Bios 606, communicating a preclusion notification. ACPI BIOS 606 may be similar as described regarding ACPI BIOS 210 of FIG. 2. User interaction device 602 receives interaction 612 causing disabling of user interaction device 602. In this manner, EC firmware 604 causes disabling of the user interaction device by way of interaction 612. EC firmware 604 may further cause saving of context information associated with user interaction device 602. Saving context information may allow for restoration of user interaction device 602 after enablement. It can be seen that the interactions and operations of FIG. 6A are performed absent intermediate operation of operating system software.

In the example of FIG. 6B, ACPI BIOS 626 receives interaction 634, from driver software 627, communicating a preclusion notification. ACPI BIOS 626 may be similar as described regarding ACPI BIOS 210 of FIG. 2. Driver software 627 may be similar as described regarding driver software 208 of FIG. 2. EC firmware 624 receives interaction 630, from user ACPI Bios 626, communicating a preclusion notification. User interaction device 622 receives interaction 632 causing disabling of user interaction device 622. In this manner, EC firmware 624 causes disabling of the user interaction device by way of interaction 632. EC firmware 624 may further cause saving of context information associated with user interaction device 622. Saving context information may allow for restoration of user interaction device 622 after enablement. It can be seen that the interactions and operations of FIG. 6B are performed absent intermediate operation of operating system software.

Even though the example of FIG. 6B illustrates EC firmware 624 receiving a preclusion notification from driver software 627 by way of ACPI BIOS 626, in at least one example embodiment, EC firmware 624 receives a preclusion notification directly from driver software 627.

In the example of FIG. 6C, driver software 647 receives interaction 656, from operating system software 648, communicating a preclusion notification. Operating system software 648 may be similar as described regarding operating system software 212 of FIG. 2. ACPI BIOS 646 may be similar as described regarding ACPI BIOS 210 of FIG. 2. ACPI BIOS 646 receives interaction 654, from driver software 647, communicating a preclusion notification. Driver software 657 may be similar as described regarding driver software 208 of FIG. 2. EC firmware 644 receives interaction 650, from user ACPI Bios 646, communicating a preclusion notification. User interaction device 642 receives interaction 652 causing disabling of user interaction device 642. In this manner, EC firmware 644 causes disabling of the user interaction device by way of interaction 652. EC firmware 644 may further cause saving of context information associated with user interaction device 642. Saving context information may allow for restoration of user interaction device 642 after enablement. It can be seen that interactions 650, 652, and 654 are performed absent operation of any operating system software. It can further be seen that operations performed by user interaction device 642, by EC firmware 644, by ACPI BIOS 646, and by driver software 647 are performed absent operation of any operating system software.

Even though the example of FIG. 6C illustrates EC firmware 644 receiving a preclusion notification from driver software 647 by way of ACPI BIOS 646, in at least one example embodiment, EC firmware 644 receives a preclusion notification directly from driver software 647.

In the example of FIG. 6D, driver software 667 receives interaction 676, from operating system software 668, communicating a preclusion notification. Operating system software 668 may be similar as described regarding operating system software 212 of FIG. 2. ACPI BIOS 666 may be similar as described regarding ACPI BIOS 210 of FIG. 2. ACPI BIOS 666 receives interaction 674, from driver software 667, communicating a preclusion notification. Driver software 677 may be similar as described regarding driver software 208 of FIG. 2. EC firmware 664 receives interaction 670, from user ACPI Bios 666, communicating a preclusion notification. User interaction device 662 receives interaction 672 causing disabling of user interaction device 662. In this manner, EC firmware 664 causes disabling of the user interaction device by way of interaction 672. EC firmware 664 may further cause saving of context information associated with user interaction device 662.

In the example of FIG. 6D, operating system software may receive interaction 680, from ACPI BIOS 666, communicating a wake notification. The wake notification may be based on a user becoming present, a user interaction device becoming enabled, and/or the like. Driver software 667 receives interaction 682, from operating system software 668, communicating a non-preclusion notification. ACPI BIOS 666 receives interaction 684, from driver software 667, communicating a non-preclusion notification. EC firmware 664 receives interaction 686, from user ACPI Bios 666, communicating a non-preclusion notification. User interaction device 662 receives interaction 688 causing enabling of user interaction device 662. In this manner, EC firmware 664 causes enabling of the user interaction device by way of interaction 688. EC firmware 664 may further cause restoring of context information associated with user interaction device 662 based on the previously saved context information.

It can be seen that interactions 670, 672, 674, 684, 686, and 688 are performed absent operation of any operating system software. It can further be seen that operations performed by user interaction device 662, by EC firmware 664, by ACPI BIOS 666, and by driver software 667 are performed absent operation of any operating system software. Even though the example of FIG. 6D illustrates EC firmware 664 receiving a preclusion notification from driver software 667 by way of ACPI BIOS 666, in at least one example embodiment, EC firmware 664 receives a preclusion notification directly from driver software 667.

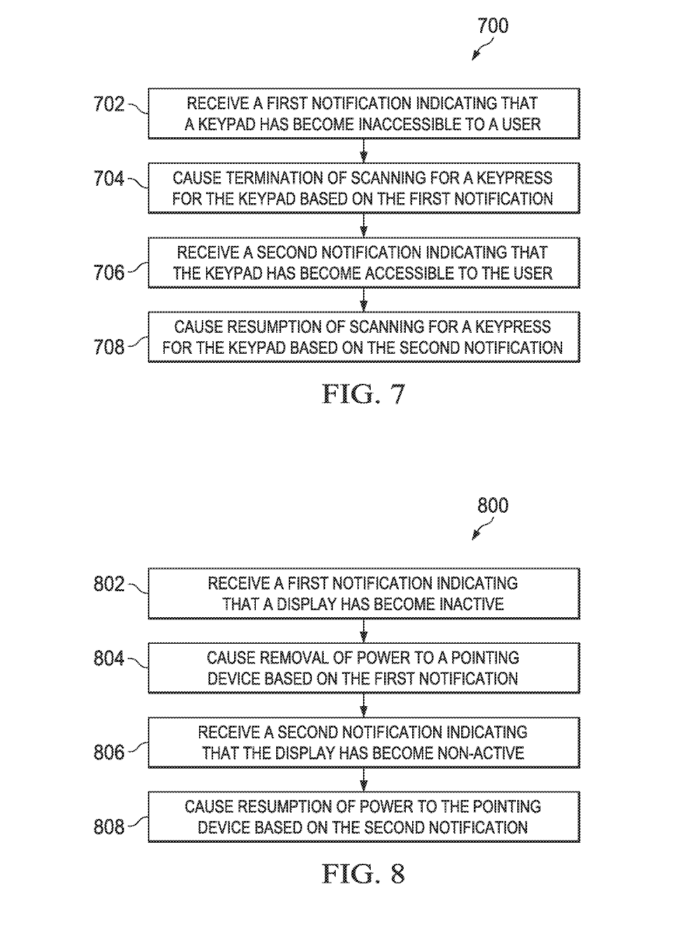

FIG. 7 is another flow diagram showing a set of operations 700 for causing disabling of a user interaction device according to at least one example embodiment. An apparatus, for example system 1100 of FIG. 10 or a portion thereof, may utilize the set of operations 700. The apparatus may comprise means, including, for example processor 1104 of FIG. 10, for performing the operations of FIG. 7. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 700. In at least one example embodiment, set of operations 700 are performed exclusive from operating system software.

At block 702, the apparatus receives a first notification indicating that a keypad has become physically precluded in that the keypad has become inaccessible to a user, similar as described regarding block 402 of FIG. 4 and similar as described regarding FIG. 1. At block 704, the apparatus causes termination of scanning for a keypress similar as described regarding block 404 of FIG. 4 and similar as described regarding FIG. 1. At block 706, the apparatus receives a second notification indicating that the keypad has become non-precluded by becoming accessible to the user, similar as described regarding block 406 of FIG. 4 and similar as described regarding FIG. 1. At block 708, the apparatus causes resumption of scanning for a keypress similar as described regarding block 408 of FIG. 4 and similar as described regarding FIG. 1.

FIG. 8 is another flow diagram showing a set of operations 800 for causing disabling of a user interaction device according to at least one example embodiment. An apparatus, for example system 1100 of FIG. 10 or a portion thereof, may utilize the set of operations 800. The apparatus may comprise means, including, for example processor 1104 of FIG. 10, for performing the operations of FIG. 8. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 800. In at least one example embodiment, set of operations 800 are performed exclusive from operating system software.

At block 802, the apparatus receives a first notification indicating that a display has become inactive, for example, the display controller is no longer providing information to be displayed, similar as described regarding block 402 of FIG. 4 and similar as described regarding FIG. 1. At block 804, the apparatus causes termination of power to a pointing device, such as a touch sensor, similar as described regarding block 404 of FIG. 4 and similar as described regarding FIG. 1. At block 806, the apparatus receives a second notification indicating that the display has become active, for example, the display controller has resumed providing information to be displayed, similar as described regarding block 406 of FIG. 4 and similar as described regarding FIG. 1. At block 808, the apparatus causes resumption of power to the pointing device similar as described regarding block 408 of FIG. 4 and similar as described regarding FIG. 1.

FIG. 9 is a simplified block diagram associated with an example ARM ecosystem SOC 1000 of the present disclosure. At least one example implementation of the present disclosure includes an integration of the features discussed herein and an ARM component. For example, the example of FIG. 9 can be associated with any ARM core (e.g., A-9, A-15, etc.). Further, the architecture can be part of any type of tablet, smartphone (inclusive of Android™ phones, i-Phones™), i-Pad™, Google Nexus™, Microsoft Surface™, personal computer, server, video processing components, Ultrabook™ system, laptop computer (inclusive of any type of notebook), any type of touch-enabled input device, etc.

In this example of FIG. 9, ARM ecosystem SOC 1000 may include multiple cores 1006-1007, an L2 cache control 1008, a bus interface unit 1009, an L2 cache 1010, a graphics processing unit (GPU) 1015, an interconnect 1012, a video codec 1020, and a liquid crystal display (LCD) I/F 1025, which may be associated with mobile industry processor interface (MIPI)/high-definition multimedia interface (HDMI) links that couple to an LDC.

ARM ecosystem SOC 1000 may also include a subscriber identity module (SIM) I/F 1030, a boot read-only memory (ROM) 1035, a synchronous dynamic random access memory (SDRAM) controller 1040, a flash controller 1045, a serial peripheral interface (SPI) master 1050, a suitable power control 1055, a dynamic RAM (DRAM) 1060, and flash 1065. In addition, one or more example embodiment include one or more communication capabilities, interfaces, and features such as instances of Bluetooth 1070, a 3G modem 1075, a global positioning system (GPS) 1080, and an 802.11 WiFi 1085.

In operation, the example of FIG. 9 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

FIG. 10 is a simplified block diagram illustrating potential electronics and logic that may be associated with any of the operations discussed herein. In at least one example embodiment, system 1100 includes a touch controller 1102, one or more processors 1104, system control logic 1106 coupled to at least one of processor(s) 1104, system memory 1108 coupled to system control logic 1106, non-volatile memory and/or storage device(s) 1110 coupled to system control logic 1106, display controller 1112 coupled to system control logic 1106, display controller 1112 coupled to a display, power management controller 1118 coupled to system control logic 1106, and/or communication interfaces 1120 coupled to system control logic 1106.

System control logic 1106, in at least one embodiment, includes any suitable interface controllers to provide for any suitable interface to at least one processor 1104 and/or to any suitable device or component in communication with system control logic 1106. System control logic 1106, in at least one example embodiment, includes one or more memory controllers to provide an interface to system memory 1108. System memory 1108 may be used to load and store data and/or instructions, for example, for system 1100. System memory 1108, in at least one example embodiment, includes any suitable volatile memory, such as suitable dynamic random access memory (DRAM) for example. System control logic 1106, in at least one example embodiment, includes one or more input/output (I/O) controllers to provide an interface to a display device, touch controller 1102, and non-volatile memory and/or storage device(s) 1110.

Non-volatile memory and/or storage device(s) 1110 may be used to store data and/or instructions, for example within software 1128. Non-volatile memory and/or storage device(s) 1110 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 1118 may include power management logic 1130 configured to control various power management and/or power saving functions disclosed herein or any part thereof. In at least one example embodiment, power management controller 1118 is configured to reduce the power consumption of components or devices of system 1100 that may either be operated at reduced power or turned off when the electronic device is in the closed configuration. For example, in at least one example embodiment, when the electronic device is in a closed configuration, power management controller 1118 performs one or more of the following: power down the unused portion of the display and/or any backlight associated therewith; allow one or more of processor(s) 1104 to go to a lower power state if less computing power is required in the closed configuration; and shutdown any devices and/or components, such as keyboard 108, that are unused when an electronic device is in the closed configuration.

Communications interface(s) 1120 may provide an interface for system 1100 to communicate over one or more networks and/or with any other suitable device. Communications interface(s) 1120 may include any suitable hardware and/or firmware. Communications interface(s) 1120, in at least one example embodiment, may include, for example, a network adapter, a wireless network adapter, a telephone modem, and/or a wireless modem.

System control logic 1106, in at least one example embodiment, includes one or more input/output (I/O) controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 1104 may be packaged together with logic for one or more controllers of system control logic 1106. In at least one example embodiment, at least one processor 1104 may be packaged together with logic for one or more controllers of system control logic 1106 to form a System in Package (SiP). In at least one example embodiment, at least one processor 1104 may be integrated on the same die with logic for one or more controllers of system control logic 1106. For at least one example embodiment, at least one processor 1104 may be integrated on the same die with logic for one or more controllers of system control logic 1106 to form a System on Chip (SoC).

For touch control, touch controller 1102 may include touch sensor interface circuitry 1122 and touch control logic 1124. Touch sensor interface circuitry 1122 may be coupled to detect touch input over a first touch surface layer and a second touch surface layer of display 11 (i.e., display device 1110). Touch sensor interface circuitry 1122 may include any suitable circuitry that may depend, for example, at least in part on the touch-sensitive technology used for a touch input device. Touch sensor interface circuitry 1122, in one embodiment, may support any suitable multi-touch technology. Touch sensor interface circuitry 1122, in at least one embodiment, includes any suitable circuitry to convert analog signals corresponding to a first touch surface layer and a second surface layer into any suitable digital touch input data. Suitable digital touch input data for one embodiment may include, for example, touch location or coordinate data.

Touch control logic 1124 may be coupled to help control touch sensor interface circuitry 1122 in any suitable manner to detect touch input over a first touch surface layer and a second touch surface layer. Touch control logic 1124 for at least one example embodiment may also be coupled to output in any suitable manner digital touch input data corresponding to touch input detected by touch sensor interface circuitry 1122. Touch control logic 1124 may be implemented using any suitable logic, including any suitable hardware, firmware, and/or software logic (e.g., non-transitory tangible media), that may depend, for example, at least in part on the circuitry used for touch sensor interface circuitry 1122. Touch control logic 1124 for one embodiment may support any suitable multi-touch technology.

Touch control logic 1124 may be coupled to output digital touch input data to system control logic 1106 and/or at least one processor 1104 for processing. At least one processor 1104 for one embodiment may execute any suitable software to process digital touch input data output from touch control logic 1124. Suitable software may include, for example, any suitable driver software and/or any suitable application software. As illustrated in FIG. 11, system memory 1108 may store suitable software 1126 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This includes the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that includes digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Example Embodiment Implementations

One particular example implementation may include an apparatus that includes a means for means for receiving (e.g., over any suitable interface, link, bus, communication pathway, etc.) a first notification indicating that at least one first user interaction device has become precluded. The apparatus also includes a means for causing disabling of at least one second user interaction device based, at least in part, on the first notification (e.g., via a processor, software, circuitry, a hub, a controller, etc.).

What is claimed is:

1. An apparatus, comprising:
logic, at least a portion of which is in hardware logic, the logic to:
receive a first notification indicative that at least one first user interaction device has become precluded; and
cause disablement of at least one second user interaction device based, at least in part, on the first notification.

2. The apparatus of claim 1, wherein the at least one first user interaction device comprises the at least one second user interaction device.

3. The apparatus of claim 1, wherein the first notification is associated with the at least one first user interaction device becoming physically precluded.

4. The apparatus of claim 1, the logic to:
determine that the at least one second user interaction device has become interactionally precluded based, at least in part, on the first notification.

5. The apparatus of claim 1, wherein the at least one second user interaction device comprises at least one of a keypad or a pointing device.

6. The apparatus of claim 1, wherein the first notification is indicative of a user being absent.

7. The apparatus of claim 1, wherein the first user interaction device and the second user interaction device comprise a keypad, and wherein the first notification indicates that the keypad has become inaccessible to a user, and wherein causation of disablement of the second device comprises termination of scanning for a keypress.

8. The apparatus of claim 7, the logic to:
receive a second notification indicative that the keypad has become uncovered such that the keypad is accessible by a user; and
cause resumption of scanning for a keypress based, at least in part, on the second notification.

9. The apparatus of claim 1, wherein the first user interaction device comprises a display, wherein the first notification indicates that the display has become inactive, and wherein the second user interaction device comprise a pointing device, and wherein causation of disablement of the pointing device comprises removal of power to the pointing device.

10. The apparatus of claim 1, the logic to:
receive a second notification indicating that a display has become active; and
cause resumption of power to a pointing device based, at least in part, on the second notification.

11. A system, comprising at least one controller, at least one first user interaction device, and at least one second user interaction device:
the controller receiving a first notification indicating that the at least one first user interaction device has become precluded; and
the controller causing disabling of the at least one second user interaction device based, at least in part, on the first notification.

12. The system of claim 11, wherein the at least one first user interaction device comprises the at least one second user interaction device.

13. The system of claim 11, wherein the first notification is associated with the at least one first user interaction device becoming physically precluded.

14. The system of claim 11:
the controller determining that the at least one second user interaction device has become interactionally precluded based, at least in part, on the first notification.

15. The system of claim 11, wherein the at least one second user interaction device comprises at least one of a keypad or a pointing device.

16. The system of claim 11, wherein the first notification is indicative of a user being absent.

17. The system of claim 11, wherein the first user interaction device and the second user interaction device comprise a keypad, and wherein the first notification indicates that the keypad has become inaccessible to a user, and wherein causing disabling of the second device comprises termination of scanning for a keypress.

18. The system of claim 17:
the controller receiving a second notification indicative that the keypad has become uncovered such that the keypad is accessible by a user; and
the controller causing resumption of scanning for a keypress based, at least in part, on the second notification.

19. The system of claim 11, wherein the first user interaction device comprises a display, wherein the first notification indicates that the display has become inactive, and wherein the second user interaction device comprises a pointing device, and wherein causation of disablement of the pointing device comprises removal of power to the pointing device.

20. A non-transitory computer readable medium comprising instructions that, when executed, cause an apparatus to:
receive a first notification indicating that at least one first user interaction device has become precluded; and
cause and absent intermediate operation of operating system software, disabling of at least one second user interaction device based, at least in part, on the first notification.

21. The medium of claim 20, wherein the at least one first user interaction device is the at least one second user interaction device.

22. The medium of claim 20, wherein the first notification is associated with the at least one first user interaction device becoming physically precluded.

23. The medium of claim 20, wherein the instructions further cause the apparatus to:
determine that the at least one second user interaction device has become interactionally precluded based, at least in part, on the first notification.

24. The medium of claim 20, wherein the at least one second user interaction device comprises at least one of a keypad or a pointing device.

25. The medium of claim 20, wherein the first notification is indicative of a user being absent.

26. The medium of claim 20, wherein the first user interaction device and the second user interaction device comprise a keypad, and wherein the first notification indicates that the keypad has become inaccessible to a user, and wherein causing disabling of the second device comprises termination of scanning for a keypress.

27. The medium of claim 26, wherein the instructions further cause the apparatus to:
receive a second notification indicative that the keypad has become uncovered such that the keypad is accessible by a user; and
cause resumption of scanning for a keypress based, at least in part, on the second notification.

28. The medium of claim 20, wherein the first user interaction device comprises a display, wherein the first notification indicates that the display has become inactive, and wherein the second user interaction device comprises a pointing device, and wherein causation of disablement of the pointing device comprises removal of power to the pointing device.

29. A method, comprising:
receiving a first notification indicating that at least one first user interaction device has become precluded; and
causing, by a processor and absent intermediate operation of operating system software, disabling of at least one second user interaction device based, at least in part, on the first notification.

30. The method of claim 11, wherein the at least one first user interaction device is the at least one second user interaction device.
